(19) United States
(12) Patent Application Publication
(10) Pub. No.: US 2014/0366579 A1
(43) Pub. Date: Dec. 18, 2014

(54) Mixing Apparatus for Substrate Ion Exchange Systems with Multi-Component Ion Exchange Baths and Methods of Mixing Such Baths

(71) Applicant: CORNING INCORPORATED, CORNING, NY (US)

(72) Inventors: Keisha Chantelle Ann Antoine, Big Flats, NY (US); Po-Hao Kao, New Taipei City (TW); Claire Jeannette Warren Ginnan, Big Flats, NY (US)

(73) Assignee: CORNING INCORPORATED, CORNING, NY (US)

(21) Appl. No.: 14/288,986

(22) Filed: May 28, 2014

Related U.S. Application Data
(60) Provisional application No. 61/835,764, filed on Jun. 17, 2013.

(51) Int. Cl. C03C 21/00

(52) U.S. Cl. CPC C03C 21/001
USPC 65/30.14; 65/157

(57) ABSTRACT

A substrate ion exchange system is provided for a multi-component ion exchange bath that minimizes stratification effects within the bath, along with methods of mixing such baths. The system includes a substrate having an outer region containing a plurality of substrate metal ions; an ion exchange bath with a first metal salt and a second metal salt; and a vessel for containing the ion exchange bath and the substrate. The system further includes a mixing apparatus configured to mix the bath such that the metal ion concentration associated with the first metal salt in the bath is substantially uniform within the vessel. The substrate metal ions are exchangeable with metal ions from the first and second metal salts. Further, the first and second metal salts are miscible and molten.

This application claims the benefit of priority under 35 U.S.C. §119 of U.S. Provisional Application Ser. No. 61/835,764, filed on Jun. 17, 2013, the content of which is relied upon and incorporated herein by reference in its entirety.

### BACKGROUND

The present disclosure relates generally to substrate ion exchange systems and methods of maintaining and controlling such systems. More particularly, the various embodiments in this disclosure relate to mixing apparatus employed in ion exchange systems for glass, glass-ceramic and ceramic articles with multi-component molten ion exchange baths, along with methods of mixing such baths.

Ion exchange (IOX) processes are employed to vary and control the concentration of metal ions in various glass, glass-ceramic and ceramic substrates through localized compositional modifications. These compositional modifications in the substrates can be used to modify certain substrate properties. For example, alkali metal ions (e.g., Na⁺ and K⁺ ions) may be imparted into surface regions of substrates as a strengthening mechanism. As another example, various heavy metal ions (e.g., Ag⁺, Cu⁺ and Zn⁺ ions) can be imparted into surface regions of substrates to provide the substrate with anti-microbial properties.

These IOX processes often involve the immersion of substrates at elevated temperatures in a multi-component ion exchange bath. The molten salt bath includes metal ions intended to be introduced into the substrates. Ions in the substrates are exchanged with the metal ions in the bath during the IOX processes, usually within an outer region of the substrate. As such, the control of the concentration of the metal ions in the bath during IOX processes is important in controlling the quantity of ions that are exchanged within the outer region of the substrates.

These concentration levels can change over time as metal ions in the bath are consumed and replaced by ions exchanged from the substrate (e.g., “effluent ions”). These changes in concentration levels are often manifested as gradual changes observed in the amount of metal ions exchanged within a series of ion exchanged substrates over an extended period time. However, there are other instances in which the amount of exchanged metal ions has unexpectedly varied within a region of a particular substrate subjected to ion exchange processes. Similarly, multiple substrates subjected to a single ion exchange process or run have been observed with significant variability in the amount of imparted metal ions from substrate to substrate, depending on the position of the substrate within the ion exchange vessel. This localized variability in the amount of imparted metal ions can result in undesired or unexpected variations in the properties of the ion exchanged substrates.

Accordingly, there is a need to develop systems and methods suitable for manufacturing operations that take into account, control and minimize the localized changes in metal ion concentration that can occur in substrates subjected to ion exchange processes over time.

### SUMMARY

According to one embodiment, a substrate ion exchange system is provided that includes a substrate having an outer region containing a plurality of substrate metal ions, an ion exchange bath that includes a first metal salt having a plurality of first metal ions at a first metal ion concentration and a second metal salt having a plurality of second metal ions at a second metal ion concentration, and a vessel for containing the ion exchange bath and the substrate. The system further includes a mixing apparatus configured to mix the bath such that the first metal ion concentration in the bath is substantially uniform within the vessel. The substrate metal ions are exchangeable with the plurality of first metal ions and the plurality of second metal ions, and the first and second metal salts are miscible and molten.

The mixing apparatus can be configured to increase the rate of dissolution of the first metal salt into the second metal salt. The mixing apparatus may also be located substantially within the vessel and can comprise an impeller assembly, a sparging assembly, a mixing frame assembly, a distributor basket or an off-line agitator assembly, among other possible variants.

According to an additional embodiment, a method of maintaining an ion exchange bath is provided. The method includes the steps: providing a substrate having an outer region containing a plurality of substrate metal ions; preparing an ion exchange bath that includes a first metal salt having a plurality of first metal ions at a first metal ion concentration and a second metal salt having a plurality of second metal ions at a second metal ion concentration; and providing a vessel for containing the ion exchange bath and the substrate. The method also includes the steps: submersing the substrate in the ion exchange bath such that a portion of the plurality of substrate metal ions is exchanged with a portion of the plurality of first metal ions; and mixing the bath such that the first metal ion concentration in the bath is substantially uniform within the vessel. Further, the first and second metal salts are miscible and molten.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is a plot depicting actual and modeled AgNO₃ concentration levels in an ion exchange bath and Ag⁺ concentration in a glass substrate, all versus number of substrate ion exchange runs in a AgNO₃—KNO₃ ion exchange bath.

FIG. 2 is a cut-away perspective view of a substrate ion exchange system with an impeller assembly in a vessel for mixing an ion exchange bath according to one embodiment.

FIG. 3A is a cut-away perspective view of a substrate ion exchange system with a removable impeller assembly in a large vessel at a raised position for mixing an ion exchange bath according to another embodiment.

FIG. 3B depicts the substrate ion exchange system in FIG. 3A in a state in which the removable impeller assembly has been moved to a position within the ion exchange bath.

FIG. 3C depicts the substrate ion exchange system in FIG. 3A in a state in which the removable impeller assembly is operating to mix the ion exchange bath within the large vessel to improve the uniformity of a first metal ion concentration within the bath.

FIG. 3D depicts the substrate ion exchange system in FIG. 3A in a state in which the impeller assembly has been moved to a position above the ion exchange bath.

FIG. 4A is a cut-away perspective view of a substrate ion exchange system with a retractable sparging assembly in a vessel for mixing an ion exchange bath according to a further embodiment.

FIG. 4B is an end-on, upward view of a bottom surface of the sparging nozzle in the sparging assembly depicted in FIG. 4A.

FIG. 4C is a cross-sectional view of the sparging nozzle in the sparging assembly depicted in FIG. 4A.

FIG. 5A is a cut-away perspective view of a substrate ion exchange system with a sparging assembly in the bottom portion of a vessel for mixing an ion exchange bath according to an additional embodiment.

FIG. 5B is a cross-sectional view of the substrate ion exchange system with a sparging assembly depicted in FIG. 5A.

FIG. 5C is a top-view of the sparging assembly depicted in FIG. 5A.

FIG. 5D is a cross-sectional view of the sparging tubes employed in the sparging assembly depicted in FIG. 5A.

FIG. 6A is a cut-away perspective view of a substrate ion exchange system with a mixing frame assembly in a vessel for mixing an ion exchange bath according to a further embodiment.

FIG. 6B provides cross-sectional views of the mixing frame assembly depicted in FIG. 6A demonstrating upward and downward motion of the frame in the ion exchange bath.

FIG. 6C is a cut-away perspective view of a substrate ion exchange system with a mixing frame assembly with vertically oriented fins in a vessel for mixing an ion exchange bath according to another embodiment.

FIG. 6D provides cross-sectional views of the mixing frame assembly depicted in FIG. 6C demonstrating upward and downward motion of the frame in the ion exchange bath.

FIG. 7 is a cut-away perspective view of a substrate ion exchange system with a distributor basket assembly in a vessel for mixing an ion exchange bath according to a further embodiment.

FIG. 8 is a cut-away perspective view of a substrate ion exchange system with an off-line agitator assembly in a tank for mixing an ion exchange bath according to an additional embodiment.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

It is now understood that the concentration levels at various locations within multi-component baths employed in substrate ion exchange processes can change as a function of time after changes are made to the ion exchange bath for various manufacturing purposes. As used herein, “stratification” or “concentration non-uniformity” in a bath refers to one or more components in a multi-component ion exchange bath (e.g., AgNO₃ and KNO₃) that de-stratify within the bath relative to their average concentration levels. That is, a AgNO₃—KNO₃ ion exchange bath with a concentration of 0.5% by weight of AgNO₃, for instance, may have localized regions with AgNO₃ concentration levels significantly below or above the average concentration level of 0.5% by weight.

Concentration non-uniformities may be produced in the bath during the initial preparation of the bath charge in which one set of metal ions, e.g., in the form of a solid metal salt, is introduced into another molten salt already in molten form. As metal ions are consumed in the bath during substrate ion exchange processes, a step of replenishing the same type of metal ions in the ion exchange bath can also lead to concentration non-uniformities in the bath. Ultimately, these localized changes in concentration levels in the baths are often manifested in undesired changes in the properties of the substrates subjected to ion exchange processes.

More particularly, the multi-component ion exchange baths employed in substrate ion exchange processes used to chemically strengthen and impart anti-microbial properties in glass, glass-ceramic and ceramic substrates can be prone to stratification. As taught by U.S. Patent Application Publication No. 2010-0028607, incorporated by reference in its entirety herein, various alkali metal ions (e.g., Li⁺, K⁺, Na⁺, Cs⁺, and Rb⁺) can be employed in salt form (e.g., KNO₃) in an ion exchange bath to chemically strengthen glass substrates immersed in such salts for a specified period of time. These alkali metal ions generally exchange with smaller alkali metal ions present in the as-formed glass substrates. As taught by U.S. Patent Application Publication No. 2012/0034435 (“the '435 Application”), incorporated by reference in its entirety herein, heavy metal ions (e.g., Ag⁺) can be employed in salt form (e.g., AgNO₃) in an ion exchange bath to impart anti-microbial properties in substrates immersed in such salts for a specified period of time. These heavy metal ions generally exchange with alkali metal ions present in the as-formed and/or chemically strengthened substrates. As also outlined by the '435 Application, the substrate ion exchange processes employing particular salts to impart strength and anti-microbial properties in the substrates are performed in a “single-step” or “dual-step” ion exchange process (SIOX and DIOX, respectively) with a multi-component bath. For example, a SIOX process may rely on a bath containing AgNO₃ and KNO₃ salts, configured to exchange both Ag⁺ and K⁺ ions into the substrates. Similarly, the second step of a DIOX process may also rely on a AgNO₃—KNO₃ molten salt bath, also configured to deliver Ag⁺ and K⁺ ions into the substrates.

It is often the case that the multi-component bath contains two or more salts that differ in density. In the AgNO₃—KNO₃ system, for example, AgNO₃ has a density of 4.35 g/cm³ and KNO₃ has a density of 2.11 g/cm³. It is believed that these density differences between the components employed in multi-component baths used in substrate ion exchange systems lead to bath concentration non-uniformity and stratification. As such, multi-component baths used in substrate ion exchange systems with components having dissimilar densities are likely more prone to stratification effects.

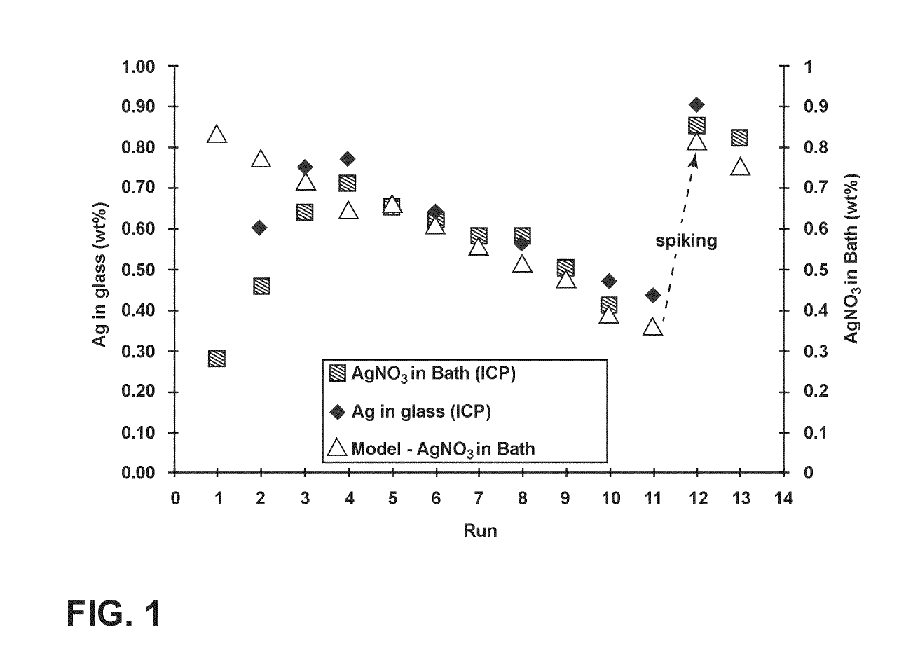

As shown in FIG. 1, for example, actual and modeled AgNO₃ concentration levels in an ion exchange bath and Ag⁺ concentration in a glass substrate are depicted versus number of substrate ion exchange runs in a AgNO₃ ion exchange bath with a bulk of KNO₃. In the experiment depicted in FIG. 1, a AgNO₃—KNO₃ ion exchange bath was prepared with roughly 0.9% AgNO₃ by weight at 420° C. for 2.5 hours. The open triangle symbols correspond to AgNO₃ concentration levels predicted by a AgNO₃-substrate ion exchange consumption model (validated through experimentation and trial runs) as a function of number of substrate ion exchange runs. As Ag⁺ ions are exchanged with metal ions in the substrate, the model predicts a decrease in AgNO₃ concentration in the bath (initially set at roughly 0.9% AgNO₃ by weight) to below 0.4% after 11 substrate ion exchange runs. At least in the first two runs, the actual AgNO₃ concentration levels measured in the bath (solid square symbols) by inductively coupled plasma (ICP) techniques and Ag⁺ ion levels measured in the processed substrates (solid diamond symbols) by ICP were significantly below those predicted by the AgNO₃-substrate ion exchange model. By the third run, the actual AgNO₃ concentration levels measured in the bath and Ag⁺ ion levels measured in the processed substrates by ICP were similar to those predicted by the AgNO₃-substrate ion exchange consumption model.

It is believed that the AgNO₃ concentration levels in the bath during the first two runs (and Ag⁺ levels in the substrate) were lower than predicted because of bath stratification effects. Although the initial AgNO₃—KNO₃ molten bath was allowed to equilibrate at 420° C. for 2.5 hours, it is likely that the AgNO₃ had not yet fully dissolved in the bulk KNO₃ during this time period. The charge of solid AgNO₃ added to the molten bulk of KNO₃ likely settled toward the bottom of the vessel containing the ion exchange bath before completely dissolving in the KNO₃ due to its significantly higher density than KNO₃. Consequently, the measured AgNO₃ levels in the bath during the first two runs shown in FIG. 1 were lower than expected as a significant quantity of the AgNO₃ in the bath was not in solution. Conversely, it is postulated that the agitation and mixing associated with immersing and removing the substrates during the first two substrate ion exchange runs increased the diffusion and dissolution of the AgNO₃ into the bulk KNO₃. After the third run, it is believed that the AgNO₃ had fully dissolved in the bulk KNO₃ because the observed AgNO₃ levels in the bath (and Ag⁺ levels in the substrates) paralleled the results predicted by the AgNO₃-substrate ion exchange consumption model.

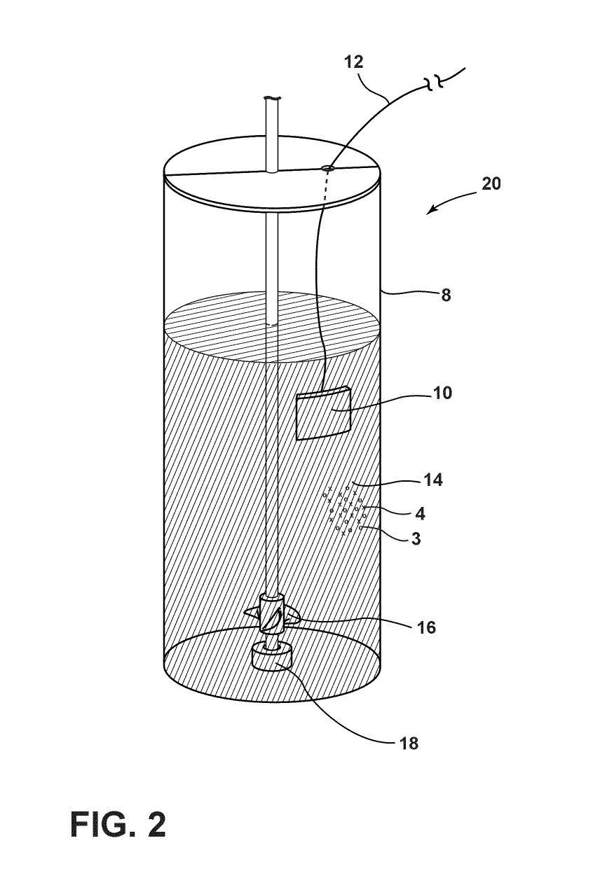

Ultimately, the data in FIG. 1 demonstrate that ion exchange bath stratification is a significant problem, particularly in multi-component baths with components having differing densities. It also shows that mixing and agitation of the ion exchange bath can reduce or eliminate stratification. As such, described herein are mixing apparatus employed in ion exchange systems with multi-component molten ion exchange baths, along with methods of mixing such baths, for ion exchange glass, glass-ceramic and ceramic substrates. These systems, and associated methods, are depicted in FIGS. 2-8. These substrate ion exchange systems are configured to take into account, control and minimize the localized changes in metal ion concentration that can occur in substrates subjected to ion exchange processes over time, particularly ion exchange processes used in manufacturing larger quantities of substrates.

As depicted in FIG. 2, a substrate ion exchange system 20 with an impeller 16 can be utilized for substrate ion exchange processes that minimize bath stratification and concentration non-uniformity according to one embodiment. In particular, substrate ion exchange system 20 includes a substrate 10 having an outer region with a plurality of substrate metal ions (not shown), typically alkali metal ions. Ion exchange system 20 further includes an ion exchange bath 14 with a first metal salt 3 and a second metal salt 4, each having a plurality of metal ions at a metal ion concentration. The salts 3 and 4 in ion exchange bath 14 are miscible and molten. Preferably, the first metal salt comprises a plurality of heavy metal ions (e.g., Ag and Cu ions). The second metal salt preferably comprises a plurality of alkali metal ions (e.g., K, Na, Rb and Li ions). In some embodiments, the densities of the first metal salt 3 and second metal salt 4 differ by more than 25%. In preferable embodiments, first metal salt 3 is AgNO₃ and second metal salt 4 is KNO₃. The initial concentration of the first metal salt 3 in the bath 14 can be set from 0.25 to 1% by weight.

During ion exchange processes employing system 20, the substrate 10 can be immersed in the bath 14 to facilitate exchange of a plurality of metal ions from first and/or second metal salts 3 and 4 with substrate metal ions contained in the outer region of substrate 10. That is, metal ions from the first metal salt 3 can be exchanged with the substrate ions in substrate 10, metal ions from the second metal salt 4 can be exchanged with the substrate ions in substrate 10 and/or metal ions from both first and second metal salts 3 and 4 can be exchanged with the substrate ions from substrate 10. As shown in FIG. 2, substrate 10 is immersed in bath 14 during ion exchange processing. A lifting member 12 (along with driving apparatus not shown), coupled to substrate 10, can be employed to move substrate 10 from a position in which the substrate 10 is immersed in the bath 14 to a raised position in which substrate 10 is not immersed in bath 14.

Ion exchange system 20 depicted in FIG. 2 also includes a vessel 8 for containing the ion exchange bath 14 and substrate 10. As readily understood by those with ordinary skill in the field, vessel 8 can be defined by various shapes and configurations to facilitate substrate ion exchange process with mixing apparatus, such as impeller 16. Vessel 8 may also possess rounded features along its bottom to facilitate consistent fluid flow of the bath 14 during mixing operations. In some embodiments, impeller 16 and bearing assembly 18 are located off-centerline of the vessel 8 to encourage turbulence and less swirling in bath 14 during mixing operations, effects likely to advantageously increase the dissolution rate of metal salts 3 and/or 4 within bath 14.

Vessel 8 can also be sized to accommodate large quantities of substrates 10 for high volume manufacturing, for example. In some embodiments, vessel 8 is configured to minimize height as increased vessel height can increase stratification and concentration non-uniformity effects in bath 14. In general, vessel 8 also contains heating components (not shown) configured for purposes of heating and maintaining the temperature of bath 14. For example, the heating components of vessel 8 can be adjusted to melt both the first and second metal salts 3 and 4. In a AgNO₃—KNO₃ system, for example, vessel 8 can be set at 420° C. to ensure that bath 14 is molten.

As also shown in FIG. 2, substrate ion exchange system 20 further includes an impeller 16, typically coupled to a bearing assembly 18 along the center-line of vessel 8. The impeller 16 and bearing assembly 18 can be sized and configured based on, among other things, the size of vessel 8 and viscosity of bath 14. Impeller 16 is configured to agitate, mix and/or otherwise move bath 14 within vessel 8 to ensure that the concentration of the first metal salt 3 and second metal salt 4 are substantially uniform throughout vessel 8. In some embodiments, impeller 16 can be particularly configured and operated to increase the dissolution rate of first metal salt 3 into a bath 14 containing a bulk of metal salt 4.

Impeller 16 is configured substantially within vessel 8 such that it can operate during or between ion exchange runs with substrates 10. For example, impeller 16 could be configured to operate at low speeds during substrate ion exchange runs with substrate 10 and at higher speeds between runs. Impeller 16 could also be operated at high speeds during periods immediately following the addition of first metal salt 3 and/or second metal salt 4 to bath 14 (e.g., during replenishing steps or preparation of the initial charge). The duration of the operation of impeller 16 during any of these phases can be based on predetermined time periods that have been calculated based on prior-obtained empirical test data. One particular advantage of the use of impeller 16 in the substrate ion exchange system 20 is that it is less likely to produce foam in cases where the first metal salt 3 or the second metal salt 4 acts as a surfactant.

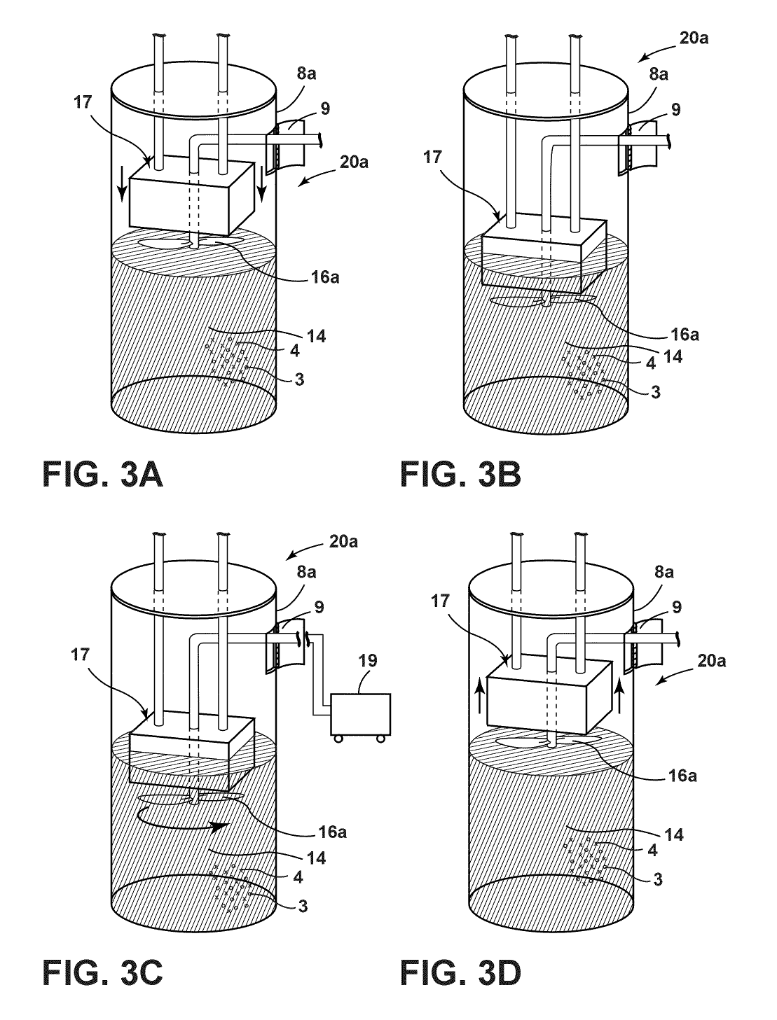

The substrate ion exchange system 20a with impeller assembly 17 depicted in FIGS. 3A-3D according to another embodiment is very similar in respects to system 20 with impeller 16 (see FIG. 2). Unless otherwise noted, like-numbered components in system 20a are configured and operate comparably to those depicted in FIG. 2 associated with substrate ion exchange system 20. In addition, impeller assembly 17 shown in FIGS. 3A-3D is similar to impeller 16 (see FIG. 2) insofar as impeller assembly 17 includes an impeller 16a that is configured to agitate, mix and/or otherwise move bath 14 within vessel 8 to ensure that the concentration of the first metal salt 3 and second metal salt 4 are substantially uniform throughout vessel 8.

In contrast to system 20, however, the impeller assembly 17 of substrate ion exchange system 20a is capable of movement into and out of bath 14, as shown successively in FIGS. 3A-3D. In FIGS. 3A to 3B, the impeller assembly 17 is moved from above bath 14 and then immersed within bath 14. After mixing bath 14 in FIG. 3C, the impeller assembly 17 can then be moved to a position back above bath 14 as shown in FIG. 3D. As readily understood by those with ordinary skill in the art, various apparatus (not shown) can be used to move impeller assembly 17 into and out of bath 14. Further, the components used to rotate impeller 17 within bath 14 can be engaged through door 9 of vessel 8a. Various components can be used drive impeller assembly 17, including impeller driving body 19 (see FIG. 3C).

As also depicted in FIGS. 3A-3D, the substrate ion exchange system 20a also includes a vessel 8a for containing the ion exchange bath 14 and the substrate 10 (not shown). Vessel 8a is generally larger than the vessel 8 to accommodate the additional apparatus necessary to move impeller assembly 17 into and out of bath 14. It should be understood that the impeller assembly 17 of system 20a can be employed to mix bath 14 after ion exchange runs with substrate 10, but not during the runs.

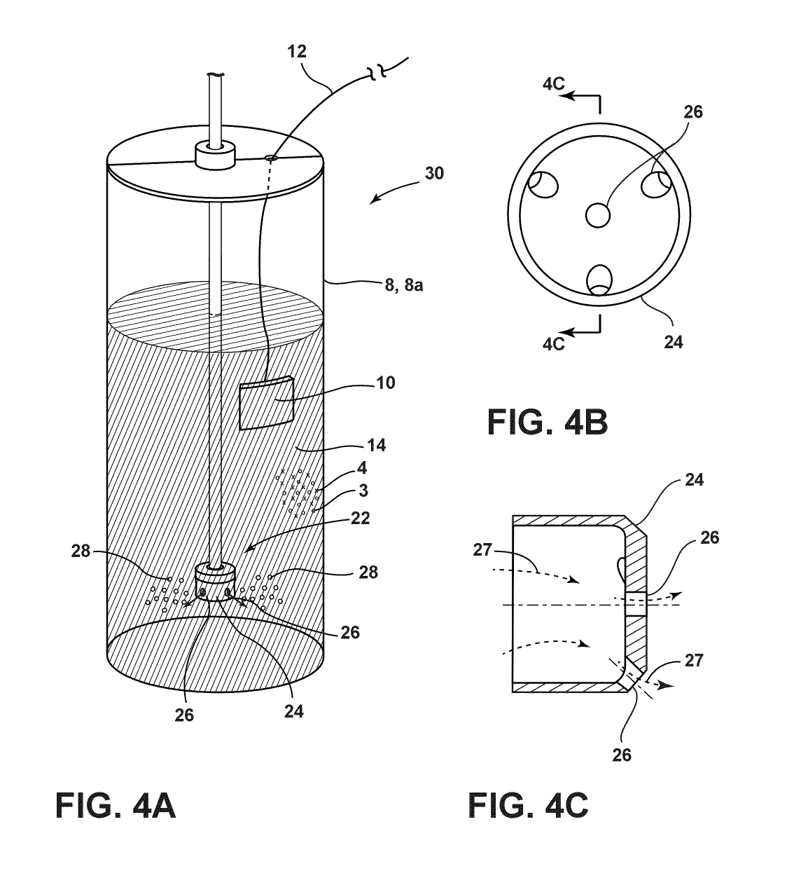

The substrate ion exchange system 30 depicted in FIGS. 4A-4C according to a further embodiment includes a sparging assembly 22 that can be utilized for substrate ion exchange processes that minimize stratification and concentration non-uniformity effects within ion exchange bath 14. The substrate ion exchange system 30 depicted in FIGS. 4A-4C is similar in respects to systems 20 and 20a (see FIGS. 2-3D). Unless otherwise noted, like-numbered components in system 30 are configured and operate comparably to those depicted in connection with systems 20 and 20a. For example, substrate 10 is immersed in bath 14 during ion exchange processing with system 30. A lifting member 12 (along with driving apparatus not shown), coupled to substrate 10, can be employed to move substrate 10 from a position in which the substrate 10 is immersed in the bath 14 to a raised position in which substrate 10 is not immersed in bath 14. Also, vessels 8 or 8a can be employed with system 30 as shown in FIGS. 4A-4C.

In contrast to systems 20 and 20a, however, the sparging assembly 22 of system 30 is configured to bubble inert gas 27 through bath 14 to agitate, mix and/or otherwise move bath 14 within vessel 8, 8a to ensure that the concentration of the first metal salt 3 and second metal salt 4 are substantially uniform throughout vessel 8, 8a. Sparging assembly 22 includes a sparging nozzle 24 with a plurality of sparging orifices 26, all immersed within bath 14 and configured to create bubbles 28 in bath 14. Sparging assembly 22 is located substantially within vessel 8, 8a. In some embodiments, sparging assembly 22 is located in proximity to, but slightly above, the bottom inner surfaces of vessel 8, 8a as depicted schematically in FIG. 4A. Further, the sparging orifices 26 can be oriented downward from nozzle 24 and outward toward the outer surfaces of vessel 8, 8a. As such, bubbles 28 emanating from orifices 26 spread uniformly throughout the bath 14 toward the bottom of vessel 8, 8a before rising toward the region of bath 14 containing the substrate 10.

In particular, the sparging assembly 22 may be operated by bubbling inert gas 27 through nozzle 24 and out of orifices 26 (see FIG. 4C). Bubbles 28 within bath 14 emanate from orifices 26. These bubbles provide the mixing action in bath 14 to prevent stratification and concentration non-uniformity effects. Various inputs can be empirically determined to optimize the reduction in stratification in bath 14 by sparging—e.g., inert gas 27 feed rate, inert gas 27 pressure, pressure of the bath 14 on the sparging assembly 22, temperature of the bath 14 and dimensions of the nozzle 24 and orifices 26. These factors can also be adjusted to ensure that the operation of sparging assembly 22 does not lead to splashing and/or undesired loss of bath 14 from vessel 8, 8a. Further, a positive pressure of inert gas 27 can be employed in sparging assembly 22 during periods of non-operation of system 30 to reduce the likelihood of frozen metal salt 3 and/or 4 from blocking and/or plugging orifices 26.

It is postulated that the bubbling action can cause un-dissolved solute of the metal salts 3 and 4 to remain suspended in bath 14. In turn, suspending the salts 3 and 4 within bath 14 allows more time for dissolution to take place before salts 3 and 4 settle within vessel 8, 8a. For example, in AgNO₃—KNO₃ systems, the bubbling action from sparging assembly 22 can suspend the denser AgNO₃ in the bath 14 immediately following the preparation of the initial charge for bath 14 or after spiking bath 14 with additional AgNO₃.

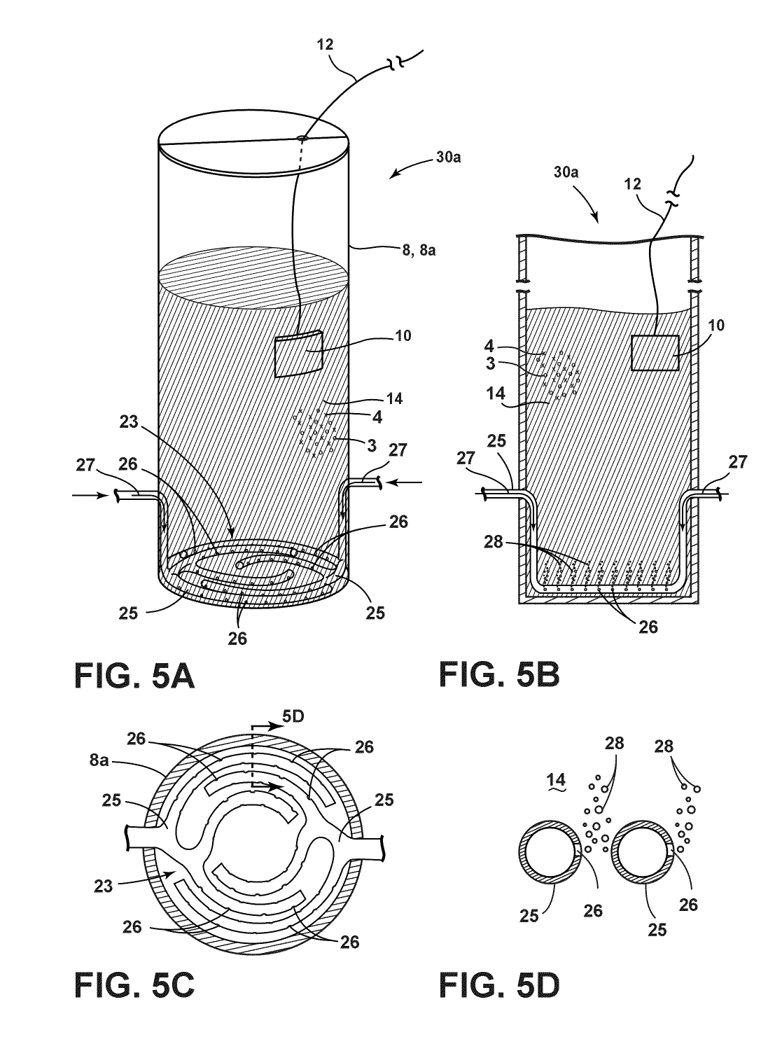

In an additional embodiment depicted in FIGS. 5A-5D, a substrate ion exchange system 30a with a sparging assembly 23 also may be employed for substrate ion exchange processes that minimize stratification and concentration non-uniformity effects within ion exchange bath 14. Substrate ion exchange system 30a is very similar to system 30 insofar as both rely on a sparging assembly to impart mixing to bath 14. Unless otherwise noted, like-numbered components in system 30a are configured and operate comparably to those depicted in connection with systems 30. In system 30a, however, a sparging assembly 23 is generally mounted to the bottom of vessel 8, 8a. Sparging assembly 23 includes a plurality of tubes 25, each configured with a plurality of orifices 26, all immersed within bath 14. The tubes 25 can exit the vessel 8, 8a through ports (not shown).

In general, sparging assembly 23 can be operated in system 30a by bubbling inert gas 27 through tubes 25 and out of orifices 26. Sparging bubbles 28 then emanate from the orifices 26 into bath 14. Preferably, the tubes 25 are arranged to cover a substantial portion of the bottom surface area of vessel 8, 8a to ensure bubbling throughout the entire volume of bath 14 within vessel 8, 8a. In some embodiments (see FIGS. 5C and 5D), the orifices 26 are arranged such that none of them directly face one another. As such, bubbles 28 emanating from orifices 26 are less likely to coalesce, as it is believed that smaller bubbles improve the mixing effect within bath 14, thereby reducing stratification effects. In other embodiments, heaters are wrapped around tubes 25 (not shown) to prevent metal salts 3 and 4 from freezing in proximity to the orifices 26, potentially clogging the tubes 25 of sparging assembly 23.

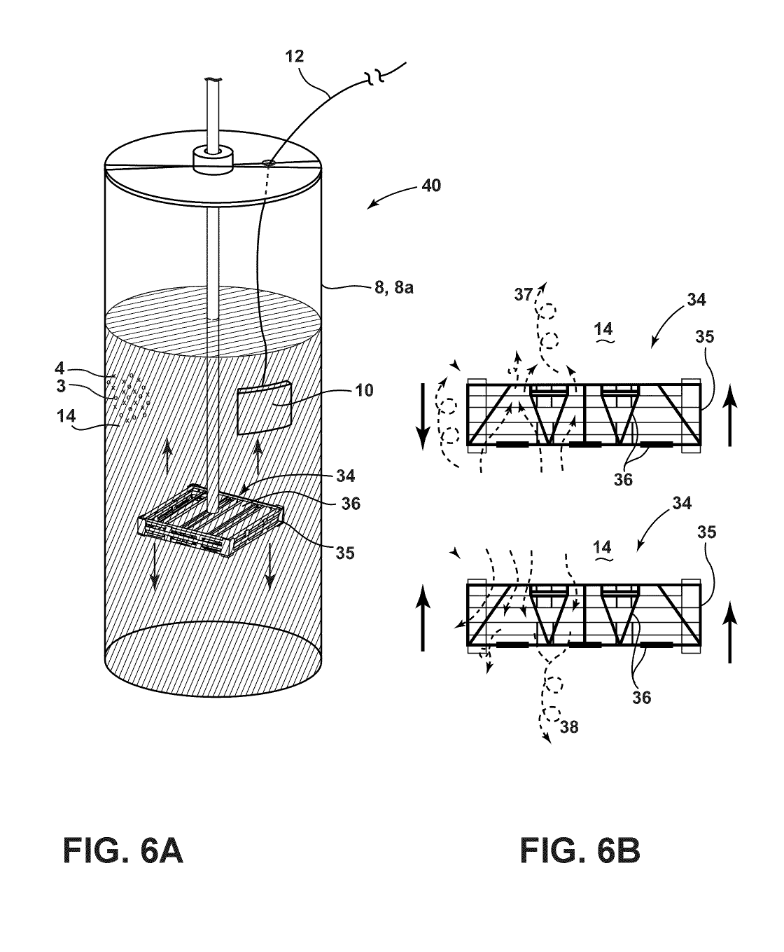

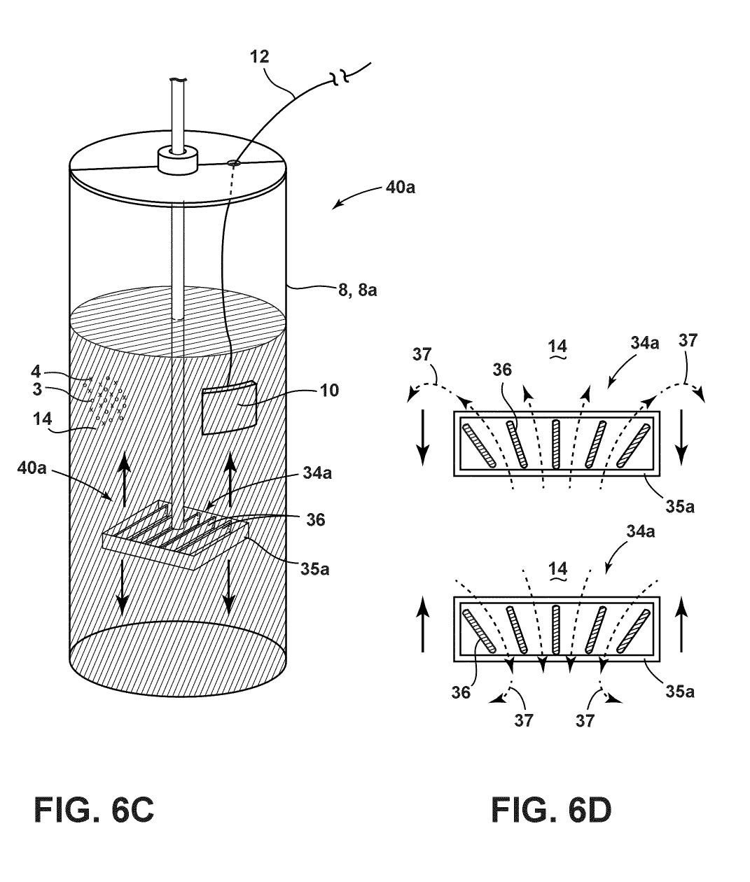

The substrate ion exchange system 40 depicted in FIGS. 6A-6B according to an additional embodiment includes a mixing frame assembly 34 that can be utilized for substrate ion exchange processes that minimize stratification and concentration non-uniformity effects within ion exchange bath 14. The substrate ion exchange system 40 depicted in FIGS. 6A and 6B is similar in respects to systems 20 and 20a (see FIGS. 2-3D). Unless otherwise noted, like-numbered components in system 40 are configured and operate comparably to those depicted in connection with systems 20 and 20a. For example, substrate 10 is immersed in bath 14 during ion exchange processing with system 40. A lifting member 12, coupled to substrate 10, can be employed to move substrate 10 from a position in which the substrate 10 is immersed in the bath 14 to a raised position in which substrate 10 is not immersed in bath 14. Also, vessels 8 or 8a can be employed with system 40 as shown in FIGS. 6A and 6B.

In contrast to systems 20 and 20a, however, the mixing frame assembly 34 of system 40 is configured to move vertically up and down through bath 14 to agitate, mix and/or otherwise move the fluids of bath 14 within vessel 8, 8a to ensure that the concentration of the first metal salt 3 and second metal salt 4 are substantially uniform throughout vessel 8, 8a. Mixing frame assembly 34 includes a mixing frame 35 having a series of “V-shaped” and horizontally-oriented fins 36. Mixing frame 35 is coupled to a shaft and other standard components (not shown) to move frame up and down within vessel 8, 8a.

As shown in FIGS. 6A and 6B, the mixing frame assembly 34 can be moved vertically within vessel 8, 8a causing cavitation within bath 14. As the mixing frame 35 is moved downward, cavitation flow 37 is directed upward within bath 14 through the frame 35 and across fins 36. When mixing frame 35 is moved upward, cavitation flow 37 is directed downward within bath 14 through the frame 35 and across fins 36. Consequently, turbulence is generated within bath 14, thus reducing stratification and concentration non-uniformity within the bath 14.

In some embodiments, horizontally-oriented fins 36 of frame 35 in system 40 provide an added benefit. During preparation of the initial charge for bath 14 or replenishment of bath 14 (i.e., spiking), the first metal salt 3 may be added in solid form to molten metal salt 4. Frame 35 in system 40 can be used for this purpose. The horizontally-oriented fins 36 can be configured to aid in distributing the first metal salt 3 into the molten bath of metal salt 4, particularly if metal salt 3 has a significantly higher density than metal salt 4. The horizontally-oriented fins 36 can control the rate at which the solid metal salt 3 contacts the molten metal salt 4. As a consequence, there is more time for the metal salt 3 to dissolve in the bulk metal salt 4 before dropping in vessel 8, 8 within the bath 14, thereby reducing stratification in bath 14.

The substrate ion exchange system 40a with a mixing frame assembly 34a depicted in FIGS. 6C and 6D according to another embodiment is very similar to system 40 depicted in FIGS. 6A and 6B. Unless otherwise noted, like-numbered components in system 40a are configured and operate comparably to those depicted in connection with systems 40. In system 40a, however, its mixing frame 35a possesses a different configuration than the mixing frame 35 employed by system 40. Here, mixing frame 35a possesses fins 36 that are generally oriented in the vertical direction with some degree of angling toward the walls of vessel 8, 8a. While these features do not offer much de-stratification benefit for the initial distribution of a solid first metal salt 3 into a molten bath 4 or spiking, the fins 36 in mixing frame 35a are particularly optimized to generate a rotational turbulence within bath 14. As the mixing frame 35a is moved downward, cavitation flow 37 is directed upward within bath 14 with a rotational component toward the walls of vessel 8, 8a. This is because the fins 36 are progressively angled toward the walls of vessel 8, 8a as a function of distance from the centermost position in frame 35a (see FIG. 6D). When mixing frame 35a is moved upward, the cavitation flow 37 is directed downward within bath 14 with a rotational component toward the walls of vessel 8, 8a. Consequently, significant turbulence is generated within bath 14 by mixing frame assembly 34a employed by substrate ion exchange system 40a, thus reducing stratification and concentration non-uniformity within bath 14.

In some embodiments of substrate ion exchange systems 40, 40a, mixing frames 35, 35a can be used to agitate and mix bath 14 in between ion exchange runs involving substrate 10. That is, systems 40, 40a can be employed during the initial preparation of bath 14 to facilitate de-stratification of the first metal salt 3 within a bulk of metal salt 4 or replenishment of bath 14 with first metal salt 3 and/or second metal salt 4. To the extent that concentration non-uniformity is observed in bath 14 during successive ion exchange runs involving a plurality of substrates 10, it is also possible to introduce mixing frames 35, 35a to agitate the bath 14 between runs.

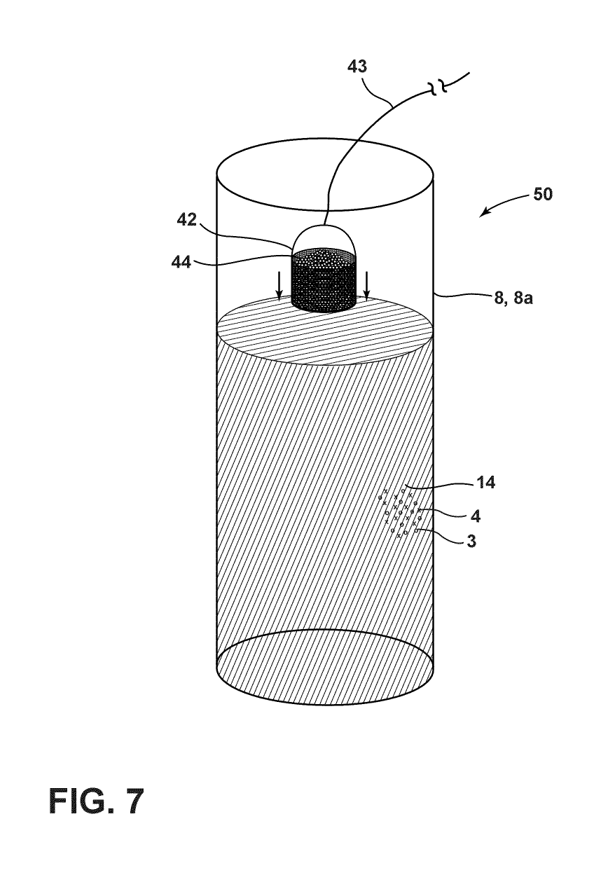

According to another embodiment, a substrate ion exchange system 50 with a distributor basket 42 is depicted in FIG. 7. Substrate ion exchange system 50 can be utilized for substrate ion exchange processes that minimize stratification and concentration non-uniformity effects within ion exchange bath 14. The substrate ion exchange system 50 depicted in FIG. 7 is similar in respects to system 40 (see FIGS. 6A and 6B). Unless otherwise noted, like-numbered components in system 50 are configured and operate comparably to those depicted in connection with system 40. For example, substrate 10 (not shown) is immersed in bath 14 during ion exchange processing with system 50. A lifting member 12, coupled to substrate 10, can be employed to move substrate 10 from a position in which the substrate 10 is immersed in the bath 14 to a raised position in which substrate 10 is not immersed in bath 14 (not shown). Also, vessel 8, 8a can be employed with system 50 as shown in FIG. 7.

Substrate ion exchange system 50 is, however, generally limited to operation in periods immediately after the preparation of a charge of ion exchange bath 14 or replenishment of bath 14 (i.e., spiking). The reason is that system 50 operates to reduce stratification by controlling the rate of introduction of a first metal salt 3 in solid form into a molten metal salt 4 (or vice versa). In particular, the distributor basket 42 is first loaded with metal salt solids 44 (e.g., metal salts 3 or 4). The basket 42 may comprise a wire mesh or other comparable configuration sized to control the distribution of solids 44 in bath 14. The distributor basket 42 is then lowered via a lift member 43 to the surface of the balance of the ion exchange bath 14, already in a molten state. Consequently, only a portion of the metal salt solids 44 is placed in contact with the molten ion exchange bath 14. This has the effect of allowing the metal salt solids (e.g., metal salts 3 or 4) more time to dissolve within ion exchange bath before settling to the bottom of vessel 8, 8a. In addition, the solids 44 must travel through the mesh portions of the basket 42, thereby increasing the surface area of solids 44 in contact with the molten ion exchange bath 14.

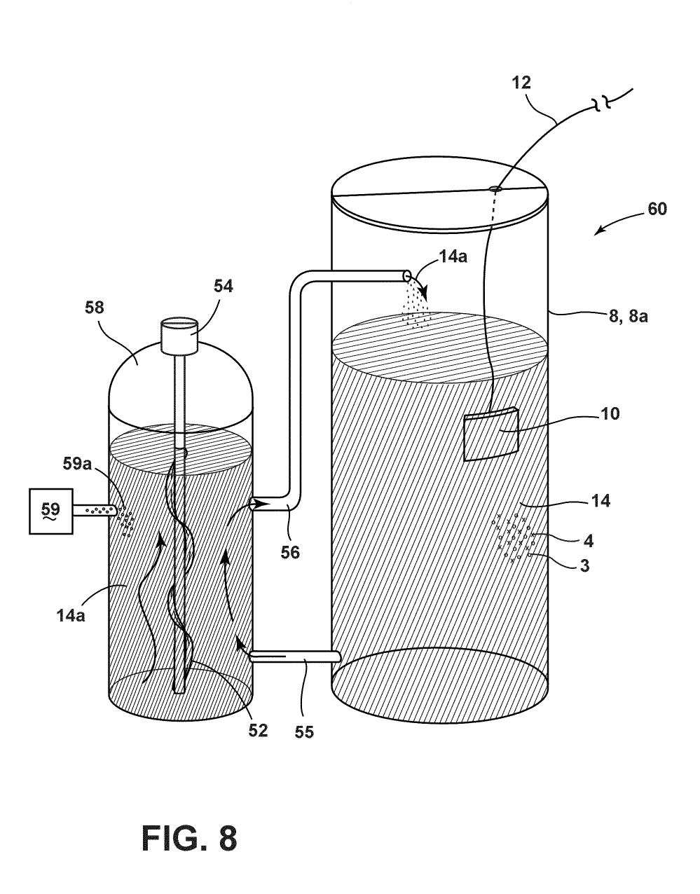

In FIG. 8, a substrate ion exchange system 60 with an agitator assembly 52 is depicted according to an additional embodiment that can be utilized for substrate ion exchange processes that minimize stratification and concentration non-uniformity effects within ion exchange bath 14. The substrate ion exchange system 60 depicted in FIG. 8 is similar in some respects to systems 20 and 20a (see FIGS. 2-3D). Unless otherwise noted, like-numbered components in system 60 are configured and operate comparably to those depicted in connection with systems 20 and 20a. For example, substrate 10 is immersed in bath 14 during ion exchange processing with system 40. A lifting member 12, coupled to substrate 10, can be employed to move substrate 10 from a position in which the substrate 10 is immersed in the bath 14 to a raised position in which substrate 10 is not immersed in bath 14. Also, vessels 8 or 8a can be employed with system 60 as shown in FIG. 8.

In contrast to systems 20 and 20a, however, the agitator assembly 52 of system 60 is arranged off-line from vessel 8, 8a. In particular, the agitator assembly 52 is located in a tank 58 with an inlet 55 and an outlet 56, both coupled to vessel 8, 8a. The inlet 55 allows ion exchange bath 14 to flow from vessel 8, 8a into tank 58. The outlet 56 allows a mixed portion of ion exchange bath 14a to flow from tank 58 into vessel 8, 8a. Further, the agitator assembly 52 is driven by a driving body 54 (e.g., a DC motor). Tank 58 also includes a feeder assembly 59 for feeding solids of metal salt 3 and/or 4 into the mixed portion of the ion exchange bath 14a.

System 60 can be operated to reduce or eliminate stratification and concentration non-uniformity in ion exchange bath 14. Agitator assembly 52 is rotated by driving body 54 within the mixed portion of ion exchange bath 14a. Flow of unmixed ion exchange bath 14 is directed through the inlet 55 into vessel 8, 8a. As the ion exchange bath 14 is mixed, it becomes a mixed portion of ion exchange bath 14a within tank 58. The mixed portion of ion exchange bath 14a is then returned to vessel 8, 8a through outlet 56. A key benefit of system 60 is that high rates of agitation and turbulence can be applied to the ion exchange bath 14 via the agitator assembly 52. Splashing is not a concern as the mixing is performed within tank 58, a substantially closed container as shown in FIG. 8. Further, the agitation in ion exchange bath 14a is performed in tank 58, at some distance from the location in vessel 8, 8a where ion exchange processes are conducted with respect to substrates 10. As such, system 60 can be employed during ion exchange processes for substrates 10 or during preparation and replenishment phases of ion exchange bath 14.

It will be apparent to those skilled in the art that various modifications and variations can be made without departing from the spirit or scope of the claims.

What is claimed is:

1. A substrate ion exchange system, comprising:
a substrate having an outer region containing a plurality of substrate metal ions;
an ion exchange bath that includes a first metal salt having a plurality of first metal ions at a first metal ion concentration and a second metal salt having a plurality of second metal ions at a second metal ion concentration;
a vessel for containing the ion exchange bath and the substrate; and
a mixing apparatus configured to mix the bath such that the first metal ion concentration in the bath is substantially uniform within the vessel,
wherein the substrate metal ions are exchangeable with the plurality of first metal ions and the plurality of second metal ions, and
further wherein the first and second metal salts are miscible and molten.

2. The substrate ion exchange system according to claim 1, wherein the mixing apparatus is further configured to increase the rate of dissolution of the first metal salt into the ion exchange bath.

3. The substrate ion exchange system according to claim 1, wherein the first and second metal salts differ in density by at least 25%.

4. The substrate ion exchange system according to claim 1, wherein the first metal salt is silver nitrate and the second metal salt is potassium nitrate.

5. The substrate ion exchange system according to claim 4, wherein the first metal ion concentration is 0.25% to 1% silver nitrate by weight.

6. The substrate ion exchange system according to claim 5, wherein the mixing apparatus is located substantially within the vessel and includes an impeller assembly.

7. The substrate ion exchange system according to claim 5, wherein the mixing apparatus is located substantially within the vessel and includes a sparging assembly.

8. The substrate ion exchange system according to claim 5, wherein the mixing apparatus is located substantially within the vessel and includes a mixing frame assembly.

9. The substrate ion exchange system according to claim 5, wherein the mixing apparatus includes a distributor basket configured to disperse the first metal salt into the bath.

10. The substrate ion exchange system according to claim 5, wherein the mixing apparatus includes an agitator assembly and a tank that are located external to the vessel, coupled to the bath and configured to mix the bath such that the first metal ion concentration in the bath is substantially uniform within the vessel.

11. The method of maintaining an ion exchange bath, comprising the steps:
providing a substrate having an outer region containing a plurality of substrate metal ions;
preparing an ion exchange bath that includes a first metal salt having a plurality of first metal ions at a first metal ion concentration and a second metal salt having a plurality of second metal ions at a second metal ion concentration;
providing a vessel for containing the ion exchange bath and the substrate;
submersing the substrate in the ion exchange bath such that a portion of the plurality of substrate metal ions is exchanged with a portion of the plurality of first metal ions; and
mixing the bath such that the first metal ion concentration in the bath is substantially uniform within the vessel, and
wherein the first and second metal salts are miscible and molten.

12. The method of maintaining an ion exchange bath according to claim 11, wherein the step of mixing the bath is also conducted to increase the rate of dissolution of the first metal salt into the ion exchange bath.

13. The method of maintaining an ion exchange bath according to claim 11, wherein the first and second metal salts differ in density by at least 25%.

14. The method of maintaining an ion exchange bath according to claim 11, wherein the first metal salt is silver nitrate and the second metal salt is potassium nitrate.

15. The method of maintaining an ion exchange bath according to claim 14, wherein the first metal ion concentration is 0.25% to 1% silver nitrate by weight.

16. The method of maintaining an ion exchange bath according to claim 15, wherein the mixing step is conducted by mixing the bath with an impeller assembly.

17. The method of maintaining an ion exchange bath according to claim 15, wherein the mixing step is conducted by bubbling an inert gas through the bath with a sparging assembly.

18. The method of maintaining an ion exchange bath according to claim 15, wherein the mixing step is conducted by moving a mixing frame through the bath.

19. The method of maintaining an ion exchange bath according to claim 15, wherein the mixing step is conducted by moving a distributor basket assembly into the bath to disperse the first metal salt into the bath.

20. The method of maintaining an ion exchange bath according to claim 15, wherein the mixing step is conducted by receiving a portion of the bath in a tank located outside of the vessel and mixing the portion with an agitator assembly located within the tank.
